(19) United States
(12) Patent Application Publication
(10) Pub. No.: US 2010/0162406 A1
(43) Pub. Date: Jun. 24, 2010

(54) SECURITY ASPECTS OF SOA

(75) Inventors: Azzedine Benameur, Caromb (FR); Paul El Khoury, Antibes (FR); Joana Da Trindade, Porto Alegre (BR)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/483,889

(22) Filed: Jun. 12, 2009

(30) Foreign Application Priority Data
Jun. 12, 2008 (EP) EP08290542.3

(51) Int. Cl. G06F 21/00; G06F 17/30

(52) U.S. Cl. 726/26; 718/100

(57) ABSTRACT

The present description refers in particular to a computer implemented method, computer program product, and computer system for dynamic separation of duties (SoD) during workflow execution. Based on at least one policy file, at a monitoring module, at least one node to be logged from a message in a message pipe of one or more messages exchanged when executing a workflow instance may be specified. Information on the at least one logged node may be passed to an enforcer. SoD violation for the at least one logged node may be checked at the enforcer. If, for the at least one logged node, SoD is violated, action may be taken based on the at least one policy file.

### CROSS-REFERENCE TO RELATED APPLICATION

This application claims priority under 35 U.S.C. §119 to European Patent Application EP08290542.3, filed Jun. 12, 2008, titled “SECURITY ASPECTS OF SOA,” which is incorporated herein by reference in its entirety.

### TECHNICAL FIELD

The description is directed generally to security aspects of service oriented architectures (SOA) and in particular to a computer-implemented method, computer system, and computer program product for dynamic separation of duties (SoD) during workflow execution.

### BACKGROUND

Web services may relate to applications that publish their interfaces and remote calls over a network such as the Internet. Web services may be used in different architectures such as remote procedure call (RPC) and service oriented architecture (SOA). SOA is widely used for today's web services since SOA is (substantially) independent from an underlying implementation. In SOA, communication between web services may be realized through XML-based messages, in particular, SOAP messages.

Web services may be used to execute workflows. At least two different ways to make web services interact in order to execute workflows exist. Interacting web services may be composed (at runtime or design time), or orchestrated at design time when all actors are known. The latter is the most common way to use web services. This orchestration is describe in an orchestration language that can be executable such as BPEL or WS-CDL.

For security reasons or to be compliant with some regulation, a requirement to workflow execution using web services may be that tasks Tₙ and Tₘ (of a workflow) are not executed by the same person and/or the same machine. In particular, assigning one person to two different tasks of a workflow may let him execute fraudulent actions. Furthermore, due to the complex nature of web services and access controls that allows delegation of duties, it may not be possible to rely on a separation of duties at design time. Hence, for security reasons separation of duties (SoD) should be enforced at runtime.

### SUMMARY

In one general aspect, a computer implemented method for dynamic separation of duties (SoD) during (at runtime) workflow execution may include specifying at a monitoring module and based on at least one policy file, at least one node to be logged from a message (which relates to or determines or specifies at least one task of a workflow) in a message pipe of one or more messages exchanged when executing a workflow instance (e.g., during runtime execution of an instance of a workflow). The method may include passing information on the at least one logged node to an enforcer, checking (e.g., testing or verifying) SoD violation (e.g., SoD conflict) for the at least one logged node at the enforcer, and, if for the at least one logged node SoD is violated (e.g., is not respected or a SoD conflict is detected), acting (which may, e.g., include taking an action) based on (e.g., according to) the at least one policy file.

A message pipe may include a list of one or more messages received at a web service and possibly stored and/or managed by a handler implementing message communication of the web service. Separation of duty (SoD) required by a workflow may be dynamically enforced when executing an instance of a workflow using a web service architecture without the need of a complementary access control mechanism. Rather, (substantially) all messages exchanged when executing a workflow instance using web services are captured and constraints are enforced on them according to at least one policy file. The exchanged messages are monitored by the monitoring module which filters and/or logs nodes of messages which may violate SoD. Detected nodes may be sent to the enforcer which enforces constraints on the logged nodes when they violate SoD according to constraints specified in the policy file.

Accordingly, with the policy file it is possible to select which nodes to log from a message and which action the enforcer should take if SoD was not respected. Consequently, although one may be used if desired, no additional authorization model is required in order to ensure SoD. Hence, full flexibility of workflow execution using web services is maintained whereby SoD can be dynamically ensured. In order to enforce SoD only nodes of exchanged messages need to be monitored and possibly logged. No propagation through the whole workflow is necessary such that less traffic (comprising less message exchange) is necessary to ensure SoD in a more flexible manner.

Furthermore, man-machine interaction is improved since a user of a workflow is no longer enforced to perform authentication and/or authorization when executing the workflow. Hence, security of workflow execution is increased such that a user is not bothered with additional security aspects due to SoD. Furthermore, SoD requirements are also not part of the workflow itself such that SoD requirements can be easily changed and/or modified for a workflow without affecting workflow execution. Furthermore, even a modified and/or changed workflow may not violate SoD enforcement since the policy file may be handled and accessed independent from the workflow itself

According to another aspect, checking SoD violation(s) may further include checking SoD violation(s) by looking at history information of the workflow instance and verifying whether at least one logged node from one or more previous messages corresponding to the workflow instance relate to the same content as the at least one logged node.

According to yet another aspect, acting based on the at least one policy file may further include (e.g., if a behavior of the at least one logged node is set to ‘active’) terminating execution of the workflow instance; and/or storing the at least one node for which SoD is violated in a log file and setting the behavior for the at least one node to ‘passive’ in the at least one policy file. According to yet another aspect, the at least one node is logged using a space-separated pair comprising a namespace and a nodename.

Accordingly, the proposed mechanism does not need a complementary access control mechanism to enforce SoD dynamically. It just uses namespaces of target web services and a node of a message (which may correspond, e.g., to a task of a workflow executed using web services) on which dynamic SoD must be ensured. The node may be specified by its nodename in the policy file. E.g., all nodes having nodename “username” may be determined in this way. By specifying a namespace and a nodename in a policy file, specific nodes of a message which may violate SoD in a specific namespace (e.g. a URL address of the message), possible candidates for SoD violation may be easily and flexible specified and dynamically filtered and/or logged at runtime without to propagate SoD enforcement through the whole workflow. SoD may be embedded at the workflow management system or workflow engine on the server side of a web service architecture. SoD integration is transparent and does not require any modification on the architecture (e.g. a web service implementation for executing workflows).

According to yet another aspect, the monitoring module and the enforcer may be deployed in a workflow management system executing the workflow instance. According to yet another aspect, the monitoring module may be placed within a stack processing the message pipe as a handler. According to yet another aspect, the monitoring module and the enforcer may be placed on a server side of a distributed architecture.

In another general aspect there is provided a computer-program product comprising computer readable instructions, which when loaded and run in a computer system and/or computer network system, cause the computer system and/or the computer network system to perform a method(s) as described.

In yet another general aspect, a computer system for dynamic separation of duties (SoD) during workflow execution may include a monitoring module configured to specify based on at least one policy file at least one node to be logged from a message in a message pipe of one or more messages exchanged when executing a workflow instance, and to pass information on the at least one logged node to an enforcer. The enforcer may be configured to check SoD violation for the at least one logged node, and act based on the at least one policy file, if for the at least one logged node SoD is violated. According to yet another aspect, the system may be further operable to perform operations according to any one of the above methods.

The subject matter described in this specification can be implemented as a method or as a system or using computer program products, tangibly embodied in information carriers, such as a CD-ROM, a DVD-ROM, a semiconductor memory, and a hard disk. Such computer program products may cause a data processing apparatus to conduct one or more operations described herein.

In addition, the subject matter described herein may also be implemented as a system including a processor and a memory coupled to the processor. The memory may encode one or more programs that cause the processor to perform one or more of the method acts described in this specification. Further, the subject matter described in this specification may be implemented using various MRI machines.

The details of one or more implementations are set forth in the accompanying drawings and the description below. Other features will be apparent from the description and drawings, and from the claims.

### BRIEF DESCRIPTION OF THE DRAWINGS

FIG. 1 shows a block diagram of an exemplary service oriented architecture (SOA).

FIG. 2 shows an exemplary sequence of a scenario of a workflow.

FIG. 3 shows a block diagram of an exemplary architecture of a dynamic separation of duties (DSoD).

FIG. 4 shows a flow diagram of exemplary interactions between dynamic separation of duties (DSoD) agents and a workflow (WF) engine.

FIG. 5 shows an exemplary specification/implementation of a dynamic separation of duties (DSoD) policy.

FIG. 6 shows and exemplary specification/implementation of a request SOAP message.

FIG. 7 shows and exemplary specification/implementation of a storage SOAP message.

FIG. 8 shows a block diagram of an exemplary Axis2 execution model.

FIG. 9 shows an exemplary configuration file for Axis2 to engage a secure logging module.

FIG. 10 shows an exemplary implementation of a secure log handler.

FIG. 11 shows an exemplary implementation of a secure logging module.

FIG. 12 shows a block diagram of an exemplary computer network system.

### DETAILED DESCRIPTION

In the following, a detailed description of examples will be given with reference to the drawings. It should be understood that various modifications to the examples may be made. In particular, elements of one example may be combined and used in other examples to form new examples.

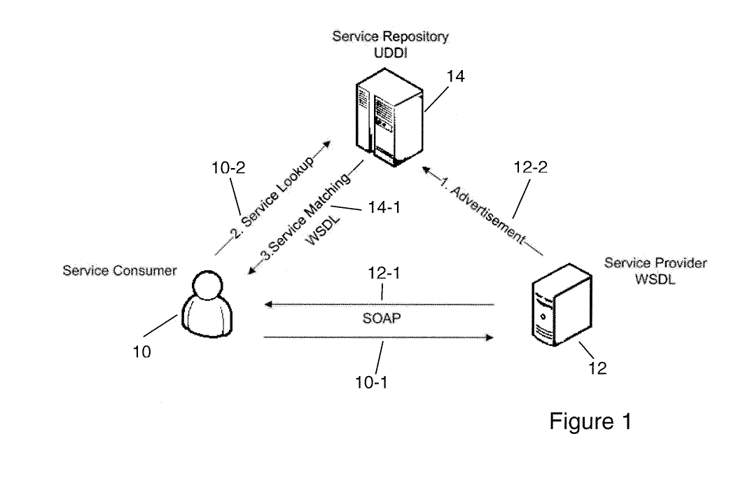

FIG. 1 shows an exemplary specification for web services using a Service Oriented Architecture (SOA). Service Oriented Architecture (SOA) may include, e.g., a computer system's architectural style or structure for creating and using processes, packaged as services through their lifecycle. SOA may define and provision at an IT infrastructure to allow different applications (e.g. computer programs, (web) services, etc.) to exchange data and/or information and participate in processes. These functions may be loosely coupled with one or more operating systems and/or programming languages underlying the applications. SOA may separate functions into different and/or distinct units (that may be referred to as services), which may distributed over a network (e.g. the Internet) and may be combined and (at least partly) reused to create applications. The services may communicate with each other by passing data and/or information from one service to another service and/or by coordinating an activity between two or more services.

According to a definition of the W3C (the World Wide Web Consortium) a web service may be “a software system designed to support interoperable machine to machine interaction over a network”. This definition may encompass a plurality of different systems. In common usage, the term may refer to clients and servers that communicate using XML-based messages following the SOAP standard. In such systems, often machine-readable descriptions of operations offered by a service written in WSDL (Web Services Description Language) may be foreseen. The use of WSDL is however not required by SOAP.

Thus, web services include applications that publish their interfaces and allow remote calls over the network. Instead of being based on SOA, web services may be used in other architectures such as Remote Procedure Call (RPC). However, today's industry standard is SOA web services. SOA-based web services may have the advantage of being independent from an underlying implementation. In SOA web services communication between services through their interfaces may be performed through SOAP messages, which, as referenced above, are XML-based.

In the exemplary SOA-based web services shown in FIG. 1, network nodes 10, 12, 14 may communicate with each other as described below. Specifically, a network node (e.g. a client) 10 sends a request message 10-1 to another network node (e.g. a server or a service provider) 12, which sends a corresponding response message 12-1 back to the client upon computation of the client request at the server 12. In one exemplary implementation, SOA web services are implemented wherein request and response messages are SOAP messages. SOAP is a protocol for exchanging XML-based messages over computer networks (e.g. the Internet), e.g. using HTTP and/or HTTPS. One or more web services hosted at the service provider 12 are exemplary specified and/or described using the Web Services Description Language (WSDL).

In one example, the service provider 12 would like to publish its at least one service. The service provider 12 therefore sends a message 12-2 to a service repository 14 which provides a repository listing and/or storing publications of web services, i.e. the service repository 14 may store lists or tables of web services which are available over a network comprising e.g. a description of available web services, conditions for accessing the web services, and/or applications for the web services. The service repository 14 may for example publish service listings and discovery of such services and how such services may interact over a network using the Universal Description, Discovery and Integration (UDDI) registry, which is XML-based. The client 10, can then lookup 10-2 a service e.g. for a particular request at the service repository 14 which response 14-1 to the client 10 with one or more web services (e.g. service 12) matching the request 10-2.

In at least one example, (SOA) web services may be combined to execute at least one workflow. In this regard, a workflow may include a computer-based specification of a sequence of operations or tasks to be performed by a person, a group of persons, and/or a machine (e.g. a computer or computer network). In general, a workflow may be a pattern of activity enabled by a systematic organization of resources, defined roles and mass, energy and information flows, into a work process that can be documented and learned through a machine. A workflow may be described using formal and/or informal flow diagramming techniques showing direct flows between processing steps. Processing steps or components of a workflow may be basically defined by at least three parameters: input description, transformation rules, and output description. The input information may comprise information, material and/or energy required to complete a step (or task in a workflow). The transformation rules may comprise algorithms which may be carried out by associated human roles, machines (computers), and/or a combination thereof The output descriptions may comprise information, material, and/or energy produced by a step (or task) of a workflow and provided as input to downstream steps (or tasks). A workflow may be defined as follows:

$$WF = {\sum }_{1}^{n} \{ {T}_{1} , {T}_{2} , … , {T}_{n} \}$$

In the equation above, WF denotes a workflow, and Tᵢ, i ∈ 1, . . . , n denotes a task. Tᵢ may comprise one or more sub-tasks tᵢ, i ∈ 1, . . . , m, that may also define at least one workflow. Tasks having sub-tasks may be the case for distributed workflows.

Web services may be composed (at runtime or design time), or orchestrated at design time when all actors are known. Web services orchestration may be described in an executable language for orchestrating web services to execute workflows, e.g. the web services Business Process Execution Language (BPEL). BPEL is a language for specifying process behavior as e.g. specified and/or modeled in one or more workflows based on web services (i.e. web services are used to execute the workflows), wherein processes (e.g. workflows) specified in BPEL export and import functionality using web service interfaces only or exclusively. Hence, to execute at least one workflow using a workflow engine (e.g. a BPEL engine) on top of a SOA web service implementation one or more messages (in particular SOAP messages) are sent to and from the web service according to one or more tasks to be executed according to an underlying workflow.

A general principle of Service Oriented Architecture (SOA) as described with reference to the example of FIG. 1 and its execution environment within a workflow engine may arise new security issues and/or aspects when executing one or more instances of at least one workflow (using SOA web services) at least due to SOA's distributed nature. In particular, such security issues and/or aspects may be related to a separation of duties (SoD).

Separation of duties (SoD) may relate to a concept of having more than one person, application program, and/or resource to complete a task specified in a workflow. In computing, SoD may be considered as a fraud prevention mechanism. By dividing tasks and/or privileges (e.g. as specified in a workflow) between users and/or machines operating and/or processing the tasks, SoD may ensure that a user alone may not violate security principles of a system. Several known SoD approaches may be based on computer-implemented Role-Based Access Control (RBAC) models which may define a set of mutually exclusive roles, each role associated to a set of privileges. In RBAC models, a user may be then assigned to a role, which grants him the corresponding privileges. In a workflow context, privileges may represent workflow tasks that a user with the correspondent role is authorized to perform. SoD approaches for workflows may be classified into two main categories: static SoD and dynamic SoD.

Static SoD approaches may not keep context information. For instance, a user assigned to role “X” is always authorized to perform any tasks associated to role “X”. Consequently, with static SoD it may be not possible to cover delegation and runtime aspects of a workflow. Such a requirement may be satisfied or achieved by enforcing dynamic SoD. In workflows, the principle of dynamic SoD may ensure that sensible workflow tasks are performed by different users and/or machines, based on available context information.

Dynamic SoD approaches may be further classified into, e.g., three main categories: object-based, operational, and history-based. This classification may consider a type of context information on which a decision for duty separation may be based. Object-based dynamic SoD may allow a user to perform a sensible task only if he has not previously performed another type of sensible task on the same object during the workflow.

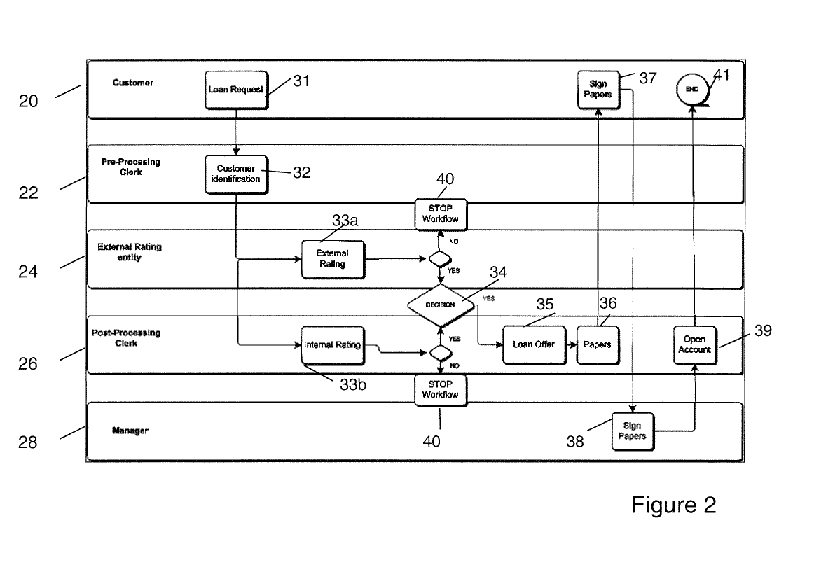

FIG. 2 shows an exemplary workflow 30 which may be executed by web services e.g. using the architecture shown in FIG. 1. In a banking workflow 30 as shown in FIG. 2 which can be executed using the (SOA) web service architecture shown in FIG. 2, a customer 20 asks for a loan by performing a loan request 31. A first user, e.g. a pre-processing clerk 22 creates the loan request comprising an identification 32 of the customer 20. In order to make the workflow 30 compliant with basic banking regulations (e.g. Sarbanes & Oxley), a second user, e.g. a post processing clerk 26 should accept the loan request 31 and then an internal ranking 33b and an external ranking 33a will be computed, wherein the first user 22 and the second user 26 should be different from each other due to security reasons. The internal ranking 33b may be computed by the second user 26, while the external ranking 33a may be computed by an external rating entity 24. Based on a decision 34 on the external ranking 33a and the internal ranking 33b, a loan offer 35 and corresponding papers 36 may be determined by the second user 26 and the papers 36 are signed 37 by the customer 20; otherwise the workflow 30 is stopped 40. Finally a manager 28 (e.g. of the bank) will give his approval 38 or not based on which the second user 26 opens an account 39 for the customer 20 and the workflow terminates 41. The different steps 31, 32, 33a, 33b, 34, 35, 36, 37, 38, 39, 40, 41 of the workflow 30 may be referred to as tasks and may be executed using SOA web services through message exchange.

When executing an instance of the workflow 30 shown in FIG. 2 using web services as specified in an architecture as shown in FIG. 1, separation of duty (SoD) should be enforced. To enforce SoD dynamically or at runtime (i.e. when or during an instance of the workflow 30 is executed by web services), it should be ensured that a user 22 (e.g. a bank employee), which is referred to as pre-processing clerk 22, that creates the loan request (e.g. by performing task 32) is not the same user, who accepts the loan request, which is referred to as post processing clerk 26. Hence, users 22 and 26 should be different persons in order to ensure SoD when executing an instance of the workflow 30 using web services.

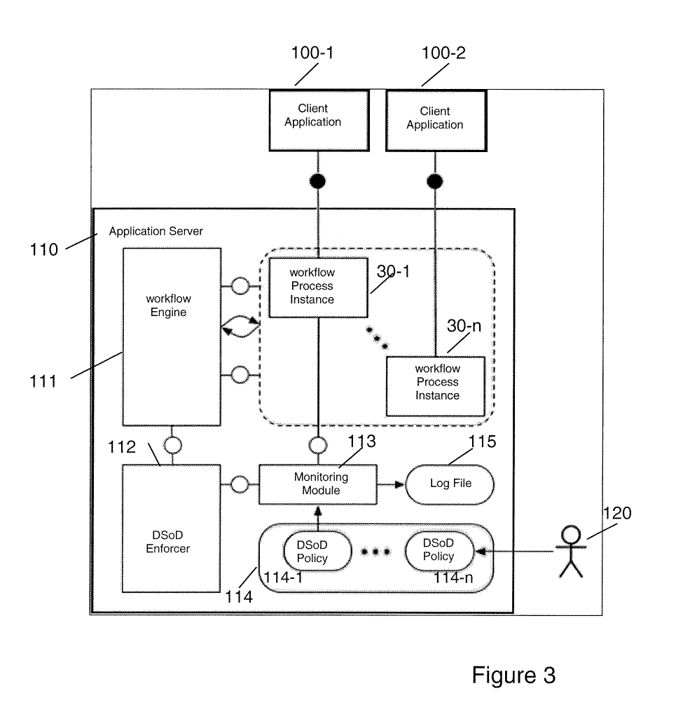

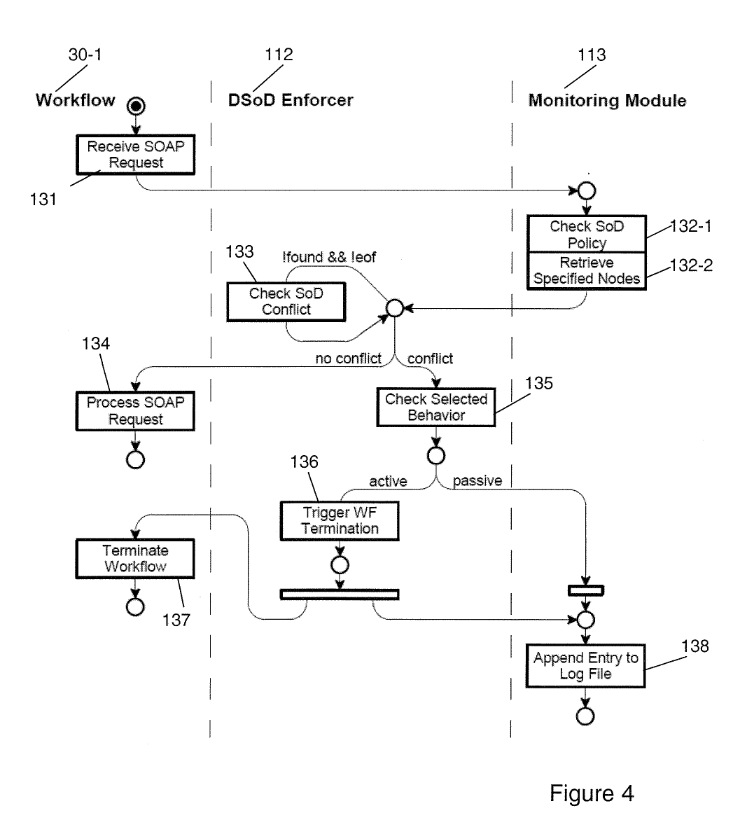

A solution of dynamic SoD for one or more workflows (e.g. workflow 30) executed using web services is shown with references to FIGS. 3 and 4. That is, to achieve dynamic SoD, a way to capture (substantially) all messages (e.g. SOAP messages) exchanged when executing an instance 30-1, 30-n of a workflow 30 using web services (e.g. SOA web services) is required or needed to be able to enforce constraints on the SOAP messages.

FIG. 3 shows an exemplary computer network-based architecture for enforcing dynamic SoD which may capture (substantially) all messages exchanged when executing a workflow instance 30-1, 30-n. The shown mechanism details an exemplary logical implementation of a solution to dynamic SoD as required for workflow execution using web services and in particular SOA web services. Software components are therefore integrated to the server side of a distributed architecture (e.g. SOA) e.g. on an application server 110 comprising a workflow engine 111. In one exemplary implementation, a BPEL workflow engine 111 may be implemented on top of an Axis web service stack.

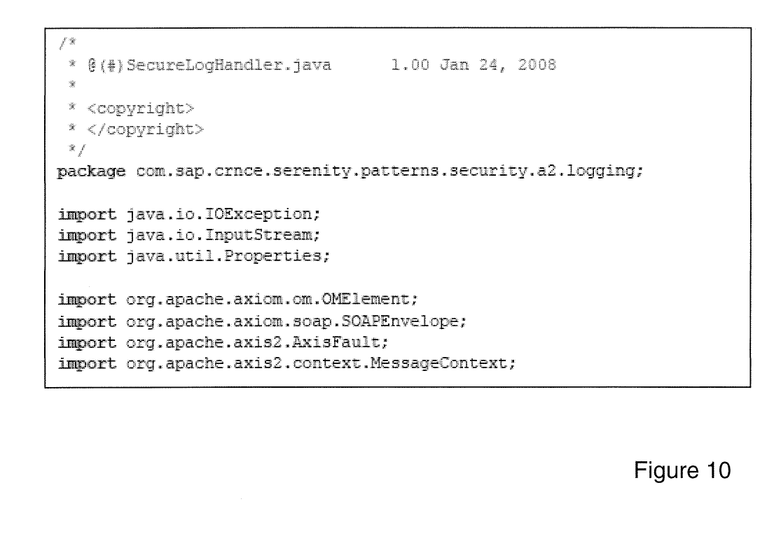

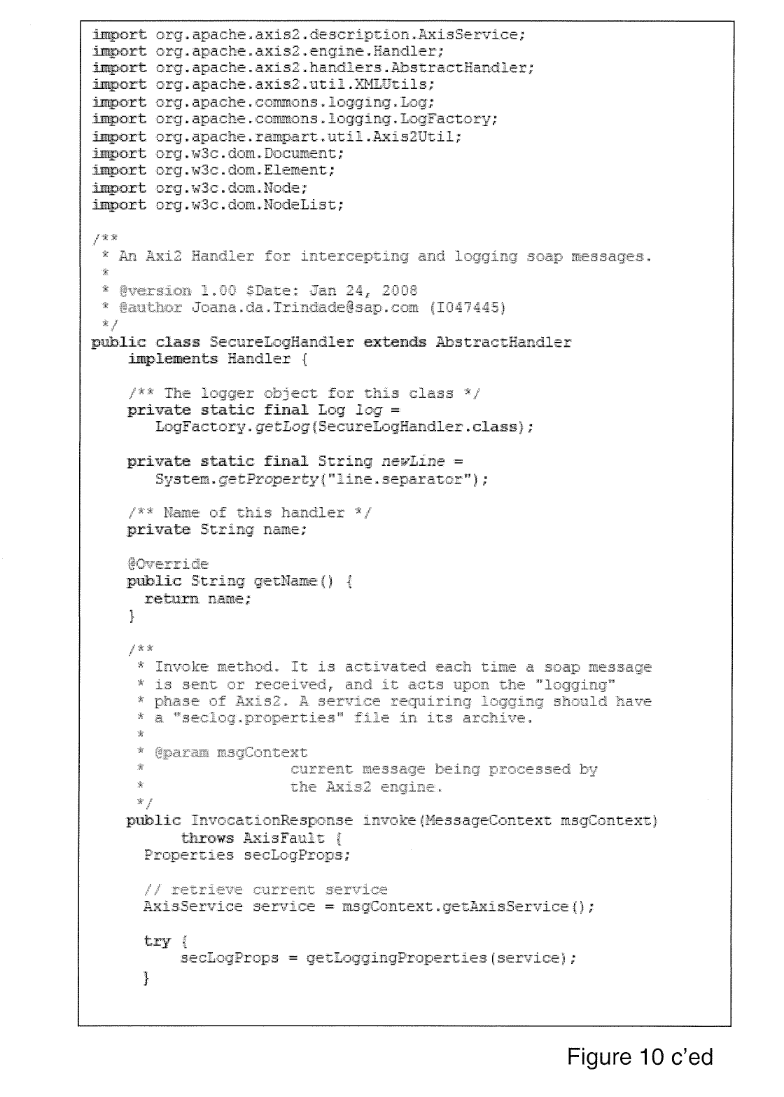

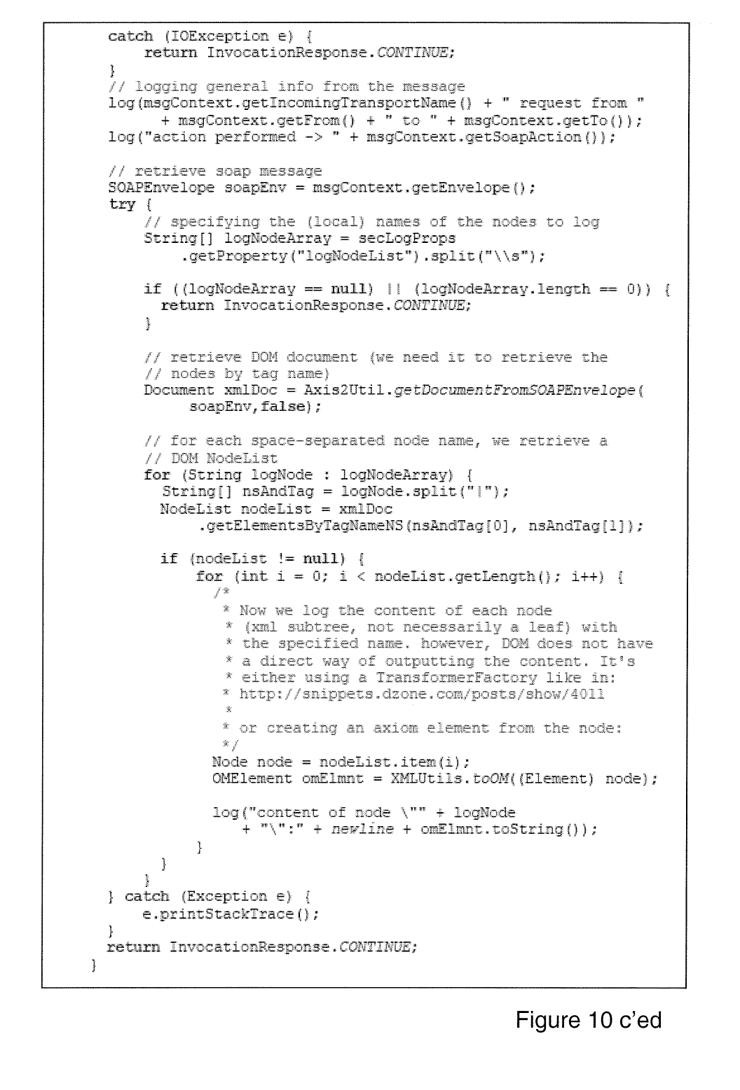

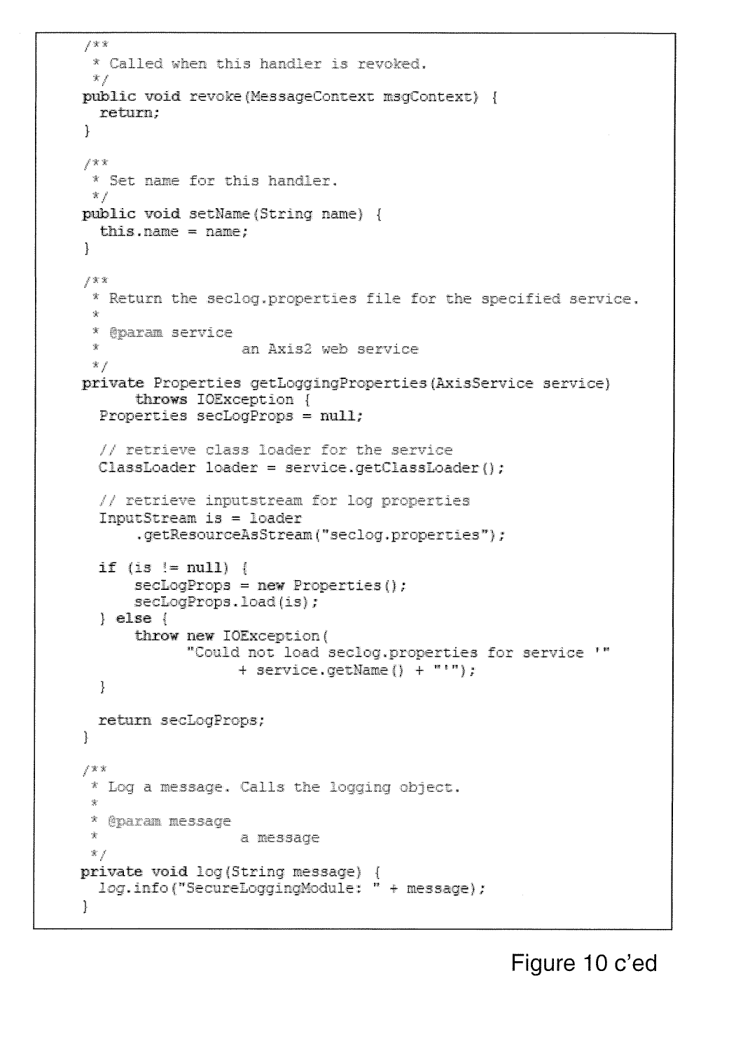

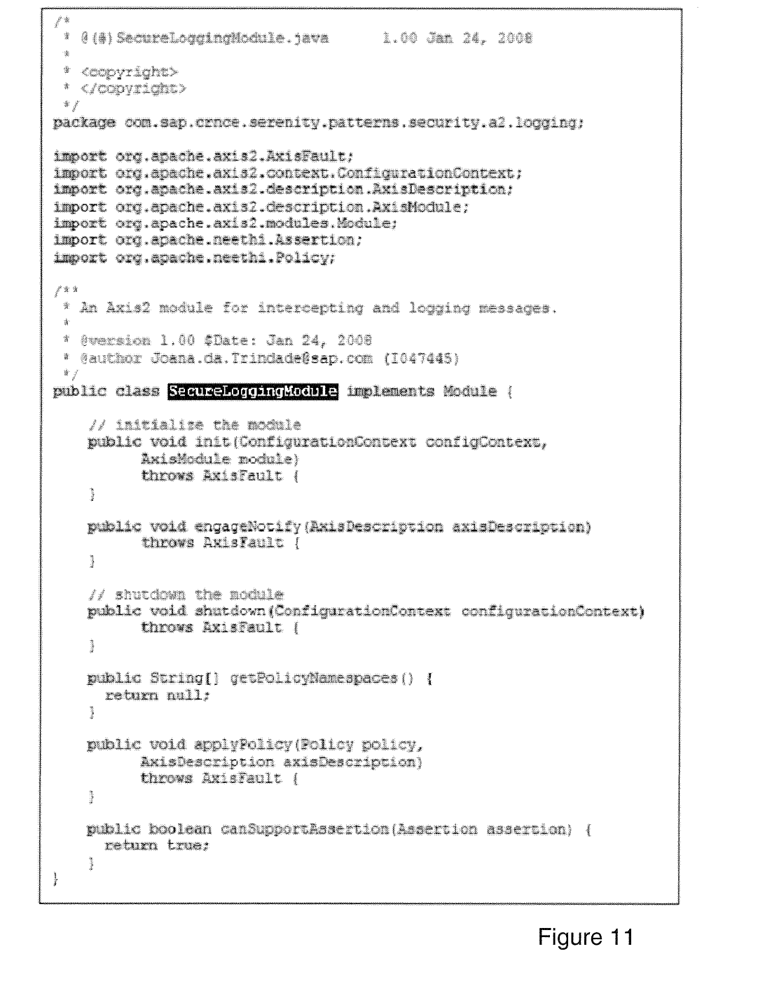

Basically, the architecture shown in FIG. 3 comprises a server or application server 110 hosting at least one web service. One or more clients or client applications 100-1 and 100-2 may access the server 110 and/or may perform requests against the server 110. The server 110 comprises a workflow management system or (workflow) engine 111 implemented on top of a web service on the server 110. The web service may be implemented through a message stack such that the workflow engine 111 may be implemented on top of the stack. The workflow engine 111 is operable to execute one or more workflow instances 30-1, 30-n of a workflow 30. A monitoring module or component 113 and a (dynamic) SoD enforcer or enforcing module or component 112 are implemented on the server 110 and deployed in the workflow engine 111. In one exemplary implementation, the monitoring module 113 is placed within a message processing stack (e.g. for processing SOAP messages) of the server 110 and is implemented as a handler. An exemplary implementation of the monitoring module handler is shown in FIGS. 10 and 11.

At least one policy (specification) file 114-1, 114-n specifies a policy comprising specifications on one or more nodes from messages which need to be monitored and/or logged e.g. in a log file 115 in order to enforce SoD dynamically. The messages are exchanged in accordance with execution of at least one instance 30-1, 30-n of a workflow 30 in the system shown in FIG. 3.

A policy may be specified in a modeling and/or programming language for computer systems (e.g. according to the Web Services Policy specified at the W3C). A policy may comprise one or more rules specifying conditions and/or requirements which must be fulfilled by an application program and/or service. Policies may be used in web services to specify authorization and/or authentication requirements of an application.

Hence, using the policy file 114-1, 114-n, which specifies one or more nodes of messages that may violate SoD when executing a workflow 30, it becomes possible to select only those nodes from exchanged messages dynamically by monitoring exchanged messages and logging only respective nodes which may not respect SoD using the monitoring module 113. Consequently, no additional authorization model is needed in association with the workflow engine 111 in order to enforce SoD dynamically. Hence, flexibility of dynamic SoD is increased since only respective nodes which might violate (or not respect) SoD should be monitored. Furthermore, no additional propagation of SoD through the whole system (e.g. through all tasks of an executed workflow) is required. In this way flexibility of workflow execution using web services and dynamic SoD may be achieved, wherein less network traffic is required, i.e. no additional messages need to be exchanged during workflow execution.

In one example, nodes that need to be logged represent a (possible) violation of SoD, e.g. if they have the same content. Such a condition of possibly violating nodes may be specified in a policy file 114-1, 114-n. Furthermore, the policy file 114-1, 114-n specifies which action should be performed on at least one node of at least one message for which SoD could be violated or not respected. Those actions are performed by the enforcer 112 who receives from the monitoring module 113 information and/or data on one or more nodes of at least one message which may violate or not respect SoD. The actions may comprise terminating a corresponding execution of an instance 30-1, 30-n of a workflow 30 executed in web service 110 through exchange of messages, e.g. SOAP messages and/or failing to respond a service request e.g. sent from a client 100-1, 100-2. In one exemplary implementation, termination of execution of the workflow instance 30-1, 30-n is performed by the enforcer 112 if a behavior of the corresponding node is set to ‘active’ in the corresponding policy file 114-1, 114-n. Another action performed by the enforcer 112 in reaction to a detected node which violates SoD is to set an attribute ‘passive’ in the policy file 114-1, 114-n for the respective node.

The policy files 114-1, 114-n used by the monitoring module 113 and the enforcer 112 may be stored in a data storage device, e.g. a policy database 114. The policy files 114-1, 114-n may be specified by a user, e.g. a system designer 120 determining SoD requirements of workflows 30 executed in the system shown in FIG. 3.

By implementing dynamic enforcement of SoD in the web service architecture as shown in FIG. 3, no complementary access control mechanism to enforce SoD dynamically (i.e. at runtime when executing a workflow instance 30-1, 30-n) is required. By implementing the monitoring module 113 and the enforcer 112 which operate on one or more SoD policies 114-1, 114-n specifying which nodes of messages exchanged when executing an instance 30-1, 30-n of a workflow 30, merely one or more namespaces of one or more target web services 110 and at least one node (of a message exchanged in response to task execution of the instance 30-1, 30-n) on which SoD should be ensured and/or enforced are required. The components 112, 113, 114, and/or 115 are embedded at a workflow management system or workflow engine 111, and its integration is transparent and does not require any modification on an underlying architecture used to execute workflows 30.

FIG. 4 shows an exemplary flow diagram of interactions between a dynamic SoD enforcer 112 and a workflow engine 111 when executing a workflow instance 30-1. The workflow engine 111 receives a message request 113 in accordance with the workflow instance 30-1 e.g. of workflow 30 to be executed e.g. using the system shown in FIG. 3. The monitoring module 113 monitoring message exchange checks 132-1 at least one SoD policy 114-1, 114-n for one or more nodes comprised in the message request and retrieve 132-2 one or more nodes for the message request which are specified according to the policy file 114-1, 114-n and which thus may violate and/or not respect SoD for the executed workflow instance 30-1. The enforcer 112 receives the one or more specified nodes from the monitoring module 113 and checks 133 for each of the one or more nodes a (possible) SoD conflict.

An exemplary SoD conflict may be that two nodes are executable by the same machine and/or person which is however not allowed according to the workflow 30 and/or that at least two nodes have the same content. If no conflict is detected for any of the one or more nodes of the message request, the request is processed 134 according to the workflow instance 30-1 at the workflow engine 111. Otherwise, if a conflict for at least one (violating) node of the one or more nodes is detected by the enforcer 112, a selected behavior for the at least one node, e.g. specified according to the underlying policy file 114-1, 114-n, is checked 135 by the enforcer 112. Depending on whether the at least one node for which a conflict is detected is set to ‘active’ or ‘passive’ in the corresponding policy file 114-1, 114-n, a termination of execution of the workflow instance 30-1 is triggered 136 by the enforcer 112 and the workflow instance 30-1 is terminated 137 by the workflow engine 111 if the at least one node is set to ‘active’. Otherwise, if the at least one node is set to ‘passive’, the monitoring module 113 receives information on the at least one node from the enforcer 112 and append 138 a corresponding entry in a log file 115 for the at least one node.

In other words, based on at least one policy file 114-1, 114-n in place (i.e. a policy file 114-1, 114-n which is used when executing a workflow instance 30-1 using the workflow engine 111), the monitoring module 113 retrieves and/or checks 132-1, 132-2 which one or more nodes to log from a (current) message in the pipe of a handler chain, which may be used to implement the server 110. The message is exchanged in accordance with a task of the underlying workflow 30 to be executed. This information is passed to the enforcer 112. The enforcer 112 checks 133 the existence of a SoD violation for the one or more logged nodes e.g. by looking at history information of the instance 30-1 of the workflow 30. For example, the enforcer 112 then verifies whether one or more logged nodes from previous messages from the (substantially) same workflow instance 30-1 present (at least part of) the (exact) same content. If yes, this may be considered a violation of SoD, and the enforcer acts 135, 136, 138 according to a behavior specified for each of the one or more logged nodes in the policy file 114-1, 114-n.

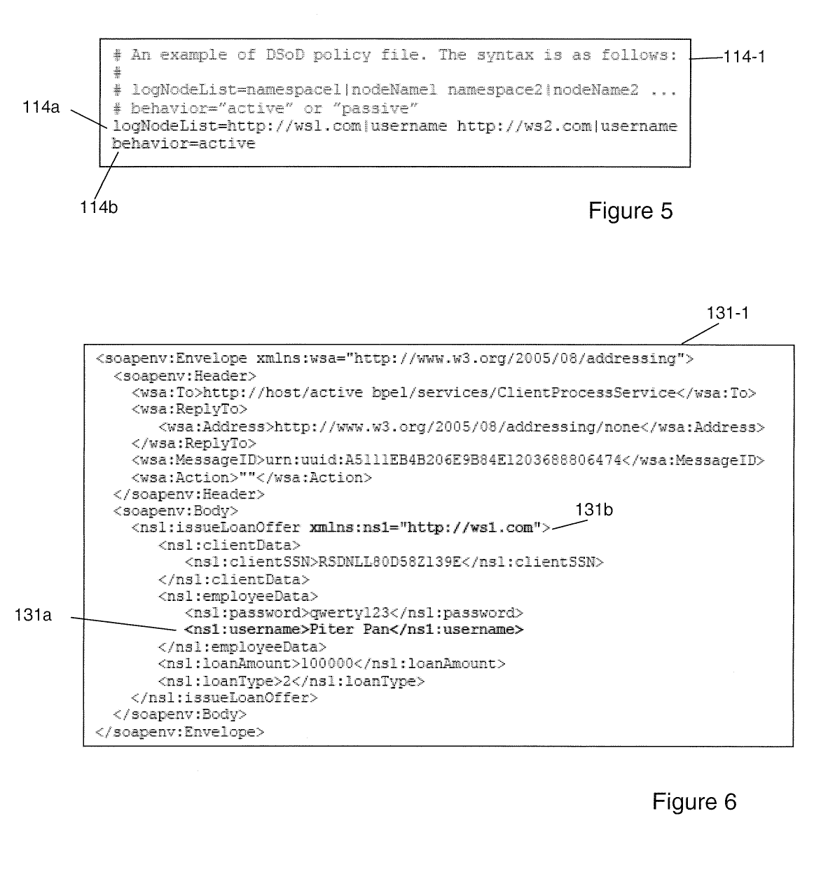

FIG. 5 shows an exemplary policy file 114-1, which may be used in the system and method as described with reference to FIGS. 3 and 4. The policy file 114-1 may be defined and/or specified using an XML-based syntax comprising definitions for a node list 114a of one or more logged nodes from one or more messages of an executed workflow instance 30-1 and an attribute “behavior” 114b denoting and/or assigning an activity status (e.g. ‘active’ and ‘passive’) to each of the one or more logged nodes. A message may correspond to a task of a workflow 30.

The node list 114a comprises a set of (space-separated) pairs of a namespace and a nodename for each of one or more nodes logged e.g. in the log file 115 of at least one message of at least one executed workflow instance 30-1. The namespace element specifies a location of the corresponding logged node, e.g. a URL or a URI specified using XML namespaces (cf. W3C specification for XML namespaces). The nodename element specifies a name of the corresponding logged node.

For example, considering the workflow 30 of FIG. 2 executed in the computer system and using the computer-implemented method according to FIGS. 3 and 4: according to the policy file 114-1 shown in FIG. 5, the monitoring module 113 is obliged to log the contents of node “username” under the namespaces “http://ws1.com” and “http://ws2.com”. Since namespaces in the node list 114a are defined in terms of a web service, using namespaces provides an adequate way to identify the destination of a message. According to the given example in FIG. 5, this means that content “username”-nodes (i.e. nodes of element “username”) from all incoming messages directed to namespaces “http://ws1.com” and “http://ws2.com” are logged.

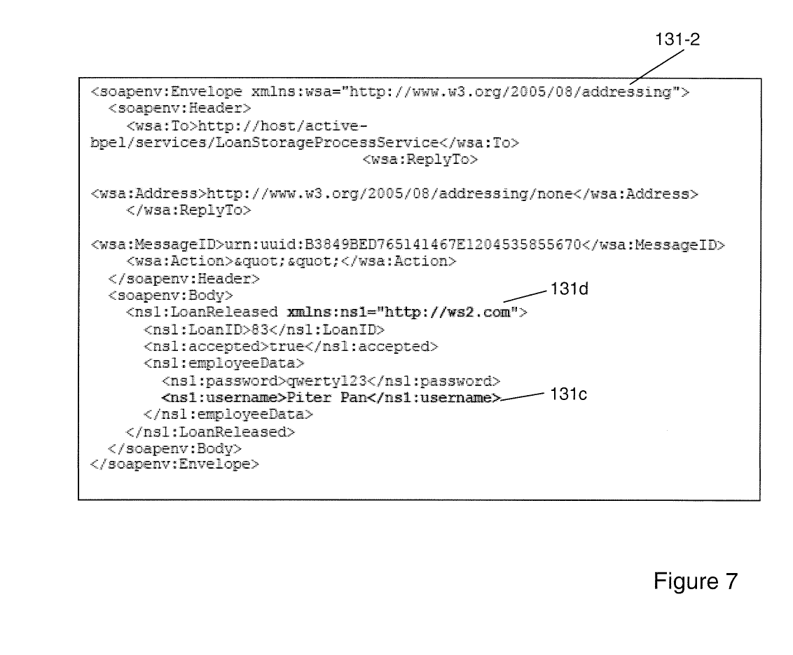

Exemplary SOAP messages for a loan request message 131-1 and a loan approval message 131-2 of the workflow 30 shown in FIG. 2 are shown in FIGS. 6 and 7, respectively. The loan request message 131-1 may correspond to task 32 and the loan approval message may correspond to task 35 of the workflow 30 when executed using web services.

In the loan request message 131-1, a node having element name “username” 131a (i.e. XML-based SOAP node <ns1:username> . . . </ns1:username>) comprises the content “Peter Pan”. Processing this message when a workflow instance 30-1 of the workflow 30 is executed and/or processed in the web services system of FIG. 3 using the computer-implemented method of FIG. 4, the monitoring module 113 logs the content (i.e. “Peter Pan”) of the node 131a according to the underlying policy file 114-1 possibly with additional information about the request 131-1, e.g. transport protocol, from, to, etc.

For example, the monitoring module 113 may output a request (e.g. http://localhost/something) to http://host/active bpel/services/ClientProcessService, e.g. the URL of a web service on server 110. Furthermore, the monitoring module 113 may output the node 131a to be logged (e.g. “<ns1:username>Piter Pan</ns1:username>”) to the log file 115 of the workflow engine 111. Subsequently, a second message 131-2 (e.g. a loan storage message) may be received at the monitoring module 113 e.g. under the http://ws2.com namespace. The second message 131-2 is logged in the log file 115 by the monitoring module 113 by logging a pair comprising a namespace “http://ws2.com” 131d and a username as specified in the username node 131c according to the policy 114-1. Accordingly, the pair (http://ws2.com, “Piter Pan”) is logged in accordance with the policy 114-1 possibly with additional information about the request 131-2, e.g. transport protocol, from, to, etc.

After the logging process, the enforcer 112 checks if the content of this second username node 131c is the same for any other nodes specified in the policy file 114-1, for the same workflow instance 30-1. According to the example shown with reference to FIGS. 5 to 7 for a workflow instance 30-1 of the workflow 30 this is true for the loan request message 131-1 and the loan approval message 131-2, i.e. for both requests the content of node username is “Peter Pan” which is logged in the log file 115 according to the policy file 114-1. As previously specified for the workflow 30 of FIG. 2, different requests having the same username may violate SoD. According to some requirements of the workflow 30, a loan request 131-1 and a loan storage request 131-2 may not be performed by the same user. This SoD conflict is detected by the enforcer 112 for messages 131-1 and 131-2 which then checks a selected behavior 114b for the logged nodes 131a and 131c according to the policy file 114-1. Since in this example the behavior 114b is set to ‘active’, the enforcer 112 triggers the termination of the workflow instance 30-1. Termination is then performed through the workflow engine 111.

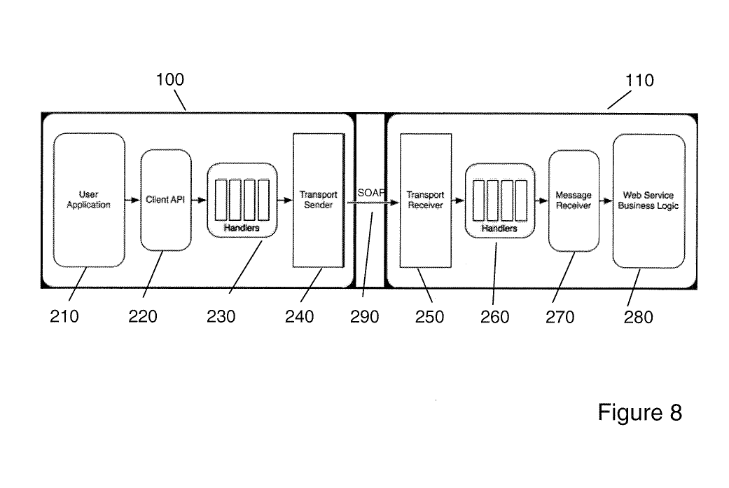

With reference to FIG. 8, an exemplary implementation of dynamic SoD in workflow execution using a distributed architecture comprising the additional components 112, 113, 114, 115 according to FIGS. 3 and 4 is shown using the Axis SOAP processing or execution model.

Axis is an XML-based framework for implementing SOA web services comprising both a Java and a C++ implementation of a SOAP server and a plurality of utilities and APIs for generating and deploying web service applications. Axis is developed under the auspices of the Apache Software Foundation. An example architecture of the Axis execution model in shown in FIG. 8. The client side 100 of the Axis execution model comprises at least one user application 210, at least one API 220 for the client 100, one or more handlers 230, and a transport sender 240, wherein communication through the components 210, 220, 230, 240 comprised in the client 100 is performed according to the direction of the arrows shown in FIG. 8, e.g. a request message is formulated in the user application 210, computed through the client API 220 and one or more handlers 230, and finally sent from the transport sender 240, which communicates with a transport receiver 250 located on the server side 110, to the server 110. Using an Axis implementation of SOA web services, messages 290 exchanged between the client 100 and the server 110 are SOAP messages 290. The server 110 comprises the transport receiver 250, one or more handlers 260, at least one message receiver 270, and a web service logic 280, wherein communication through the components 250, 260, 270, 280 comprised in the server 110 is performed according to the direction of the arrows shown in FIG. 8. For example, a request 290 from the client 100 received at the transport receiver 250 is processed and/or computed through the handlers 260, the message receiver 270, and the web service logic 280 in order to compute a response to the client request 290. The handlers 230, 260 may be implemented as stacks using a FIFO (first in first out) and/or LIFO (last in first out) principle.

In other words, the Axis SOAP processing model is based on a pipe of sequential actions performed by so-called handlers. Examples of these actions may be message routing, security headers processing (comprising e.g. XML encryption, XML signature, etc.), and message dispatching.

In one exemplary implementation, the Axis execution model of FIG. 8 is used to implement the architecture of FIG. 3 for dynamic enforcement of DoS during runtime execution of workflows together with an Axis-based workflow engine 111 on top of an Axis web services stack. Using an Axis-based workflow engine 111, messages (SOAP messages) need to be captured in the Axis stack or SOAP processing model.

In order to allow for dynamic SoD, SOAP processing using the Axis processing model may be extended by placing customized handlers in the message processing chain of FIG. 8. These handlers can be invoked by the Axis engine, and act upon at least one current SOAP message in the pipe of the Axis processing model.

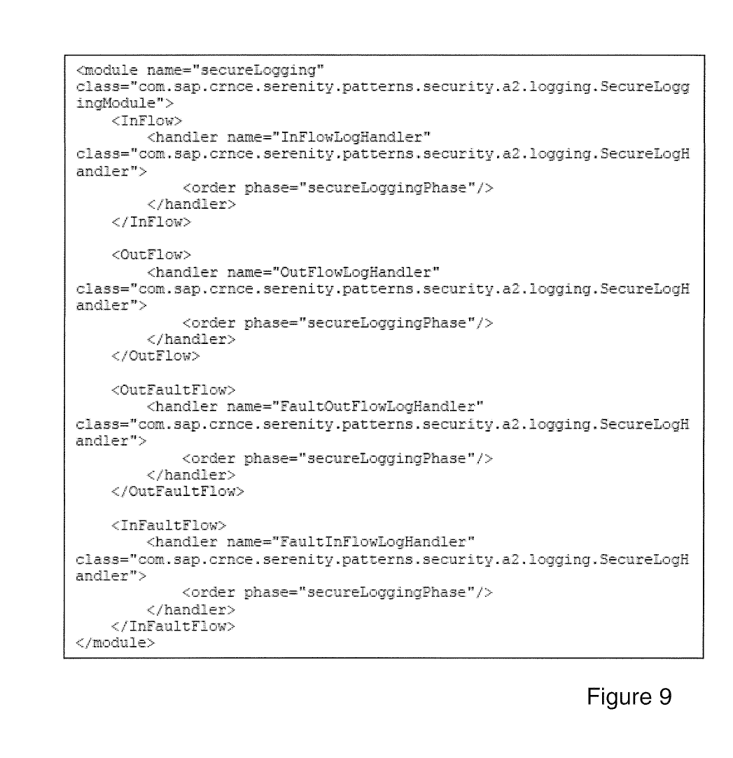

In the exemplary implementation using the Axis processing model of FIG. 8, the monitoring module 113 may be implemented as a handler, and placed on the server side 110 of the Axis handler chain. FIGS. 9 to 11 show an exemplary implementation of the handlers in particular of an exemplary implementation of the monitoring module 113 for intercepting and/or logging messages exchanged when executing a workflow instance 301, 30-n.

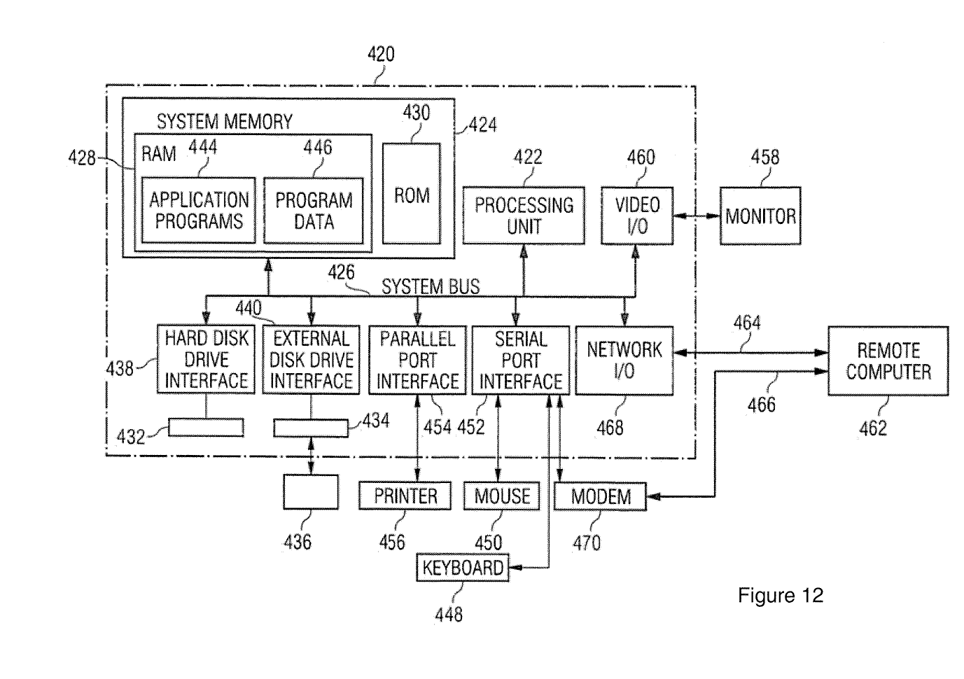

With reference to FIG. 12, an exemplary system for implementing the invention includes a general purpose computing device in the form of a conventional computing environment 420 (e.g. personal computer), including a processing unit 422, a system memory 424, and a system bus 426, that couples various system components including the system memory 424 to the processing unit 422. The processing unit 422 may perform arithmetic, logic and/or control operations by accessing system memory 424. The system memory 424 may store information and/or instructions for use in combination with processing unit 422. The system memory 424 may include volatile and non-volatile memory, such as random access memory (RAM) 428 and read only memory (ROM) 430. A basic input/output system (BIOS) containing the basic routines that helps to transfer information between elements within the personal computer 420, such as during start-up, may be stored in ROM 430. The system bus 426 may be any of several types of bus structures including a memory bus or memory controller, a peripheral bus, and a local bus using any of a variety of bus architectures.

The personal computer 420 may further include a hard disk drive 432 for reading from and writing to a hard disk (not shown), and an external disk drive 434 for reading from or writing to a removable disk 436. The removable disk may be a magnetic disk for a magnetic disk driver or an optical disk such as a CD ROM for an optical disk drive. The hard disk drive 434 and external disk drive 434 are connected to the system bus 426 by a hard disk drive interface 438 and an external disk drive interface 440, respectively. The drives and their associated computer-readable media provide nonvolatile storage of computer readable instructions, data structures, program modules and other data for the personal computer 420. The data structures may include relevant data of the implementation of the method for dynamic separation of duties (SoD) during workflow execution, as described in more details below. The relevant data may be organized in a database, for example a relational or object database.

Although the exemplary environment described herein employs a hard disk (not shown) and an external disk, it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules may be stored on the hard disk, external disk, ROM 430 or RAM 428, including an operating system (not shown), one or more application programs, other program modules (not shown), and program data. The application programs may include at least a part of the functionality as detailed in FIGS. 1 to 11.

A user may enter commands and information, as discussed below, into the personal computer 420 through input devices such as keyboard 448 and mouse 450. Other input devices (not shown) may include a microphone (or other sensors), joystick, game pad, scanner, or the like. These and other input devices may be connected to the processing unit 422 through a serial port interface 452 that is coupled to the system bus 426, or may be collected by other interfaces, such as a parallel port interface 454, game port or a universal serial bus (USB). Further, information may be printed using printer 456. The printer 456, and other parallel input/output devices may be connected to the processing unit 422 through parallel port interface 454. A monitor 58 or other type of display device is also connected to the system bus 26 via an interface, such as a video input/output 460. In addition to the monitor, computing environment 420 may include other peripheral output devices (not shown), such as speakers or other audible output.

The computing environment 420 may communicate with other electronic devices such as a computer, telephone (wired or wireless), personal digital assistant, television, or the like. To communicate, the computer environment 420 may operate in a networked environment using connections to one or more electronic devices. FIG. 12 depicts the computer environment networked with remote computer 462. The remote computer 462 may be another computing environment such as a server, a router, a network PC, a peer device or other common network node, and may include many or all of the elements described above relative to the computing environment 420. The logical connections depicted in FIG. 12 include a local area network (LAN) 464 and a wide area network (WAN) 466. Such networking environments are commonplace in offices, enterprise-wide computer networks, intranets and the Internet.

When used in a LAN networking environment, the computing environment 420 may be connected to the LAN 464 through a network I/O 468. When used in a WAN networking environment, the computing environment 420 may include a modem 470 or other means for establishing communications over the WAN 466. The modem 470, which may be internal or external to computing environment 420, is connected to the system bus 426 via the serial port interface 452. In a networked environment, program modules depicted relative to the computing environment 420, or portions thereof, may be stored in a remote memory storage device resident on or accessible to remote computer 462. Furthermore other data relevant to the application of the insurance claim management evaluation method (described in more detail further below) may be resident on or accessible via the remote computer 462. The data may be stored for example in an object or a relation database. It will be appreciated that the network connections shown are exemplary and other means of establishing a communications link between the electronic devices may be used.

The above-described computing system is only one example of the type of computing system that may be used to implement the method for dynamic separation of duties (SoD) during workflow execution.

What is claimed is:

1. A computer-implemented method for dynamic separation of duties (SoD) during workflow execution, the method comprising:
specifying at a monitoring module, based on at least one policy file, at least one node to be logged from a message in a message pipe of one or more messages exchanged when executing a workflow instance;
passing information on the at least one logged node to an enforcer;
checking SoD violation for the at least one logged node at the enforcer; and
if for the at least one logged node SoD is violated, acting based on the at least one policy file.

2. The method according to claim 1, wherein checking SoD violation further comprises:
checking SoD violation by looking at history information of the workflow instance and verifying whether at least one logged node from one or more previous messages corresponding to the workflow instance relate to the same content as the at least one logged node.

3. The method according to claim 1, wherein acting based on the at least one policy file further comprises:
if a behavior of the at least one logged node is set to ‘active’, triggering termination of execution of the workflow instance; and/or
storing the at least one node for which SoD is violated in a log file and setting the behavior for the at least one node to ‘passive’ in the at least one policy file.

4. The method according to claim 1, wherein the at least one node is logged using a pair comprising a namespace and a nodename.

5. The method according to claim 1, wherein the monitoring module and the enforcer are deployed in a workflow management system executing the workflow instance.

6. The method according to claim 1, wherein the monitoring module is placed within a stack processing the message pipe as a handler.

7. The method according to claim 1, wherein the monitoring module and the enforcer are located on a server side of a distributed architecture.

8. A computer system for dynamic separation of duties (SoD) during workflow execution, the system including instructions recorded on a computer-readable medium, the system comprising:
a monitoring module configured to:
specify based on at least one policy file at least one node to be logged from a message in a message pipe of one or more messages exchanged when executing a workflow instance; and
pass information on the at least one logged node to an enforcer;
wherein the enforcer is configured to:
check SoD violation for the at least one logged node; and
act based on the at least one policy file, if for the at least one logged node SoD is violated.

9. The system according to claim 8, wherein the enforcer is further operable to:
check SoD violation including looking at history information of the workflow instance and verifying whether at least one logged node from one or more previous messages corresponding to the workflow instance relate to the same content as the at least one logged node.

10. The system according to claim 8, wherein the enforcer is further configured to act based on the at least one policy file including:
triggering termination of execution of the workflow instance, if a behavior of the at least one logged node is set to ‘active’; and/or
storing the at least one node for which SoD is violated in a log file and setting the behavior for the at least one node to ‘passive’ in the at least one policy file.

11. The system according to claim 8, wherein the at least one node is logged using a pair comprising a namespace and a nodename.

12. The system according to claim 8, wherein the monitoring module and the enforcer are deployed in a workflow management system executing the workflow instance.

13. The system according to claim 8, wherein the monitoring module is placed within a stack processing the message pipe as a handler.

14. The system according to claim 8, wherein the monitoring module and the enforcer are placed on a server side of a distributed architecture.

15. Computer program product comprising computer readable instructions, which when loaded and run in a computer and/or computer network system, causes the computer system and/or the computer network system to:
specify at a monitoring module, based on at least one policy file, at least one node to be logged from a message in a message pipe of one or more messages exchanged when executing a workflow instance;
pass information on the at least one logged node to an enforcer;
check SoD violation for the at least one logged node at the enforcer; and
if for the at least one logged node SoD is violated, act based on the at least one policy file.

16. The computer program product of claim 15 wherein SoD violation is checked by looking at history information of the workflow instance and verifying whether at least one logged node from one or more previous messages corresponding to the workflow instance relate to the same content as the at least one logged node.

17. The computer program product of claim 15, wherein action based on the at least one policy file includes:
if a behavior of the at least one logged node is set to ‘active’, triggering termination of execution of the workflow instance; and/or
storing the at least one node for which SoD is violated in a log file and setting the behavior for the at least one node to ‘passive’ in the at least one policy file.

18. The computer program product of claim 15, wherein the at least one node is logged using a pair comprising a namespace and a nodename.

19. The computer program product of claim 15, wherein the monitoring module and the enforcer are deployed in a workflow management system executing the workflow instance.

20. The computer program product of claim 15, wherein the monitoring module is placed within a stack processing the message pipe as a handler.
